(19) United States
(12) Patent Application Publication
(10) Pub. No.: US 2015/0125223 A1
(43) Pub. Date: May 7, 2015

(54) CUTTING TOOL WITH CLOSED POCKET DESIGN

(71) Applicant: Kennametal Inc., Latrobe, PA (US)

(72) Inventors: Michael Glenn Morrison, Tarrs, PA (US); Brad Daniel Hoffer, White, PA (US); Jeffrey Francis Kovac, Loyalhanna, PA (US)

(73) Assignee: Kennametal Inc., Latrobe, PA (US)

(21) Appl. No.: 14/074,546

(22) Filed: Nov. 7, 2013

(51) Int. Cl. B23B 27/16

(52) U.S. Cl. CPC B23B 27/16; B23B 2205/12; B23B 2210/06
USPC 407/5; 407/66; 407/102

(57) ABSTRACT

A cutting tool includes a pocket with a top wall, a bottom wall, a first side wall for engaging an insert cartridge, a second side wall, a first rear wall, and a second rear wall. The top wall and the bottom wall are formed at a negative angle with respect to each other to provide a closed pocket design that resists centrifugal forces when the insert cartridge and the clamp wedge are in a locked condition during a cutting operation.

### BACKGROUND OF THE INVENTION

1. Field of the Invention

The invention pertains to the field of cutting tools. More particularly, the invention pertains to a cutting tool with a closed pocket design that resists centrifugal forces during a cutting operation.

2. Description of Related Art

Conventional cutting tools with insert cartridges use various means for mounting the insert cartridges to the tool body. One known method of clamping an insert cartridge in a pocket of a cutting tool is by means of a clamp wedge. Unfortunately, the insert cartridge has a tendency to fly out of the pocket at higher cutting speeds due to centrifugal forces, thereby increasing cycle times and associated costs.

### SUMMARY OF THE INVENTION

The problem of securely clamping an insert cartridge in a pocket of a cutting tool is solved by providing a cutting tool with a closed pocket design that resists centrifugal forces during a cutting operation.

In one aspect of the invention, a cutting tool comprises a pocket including a top wall, a bottom wall, a first side wall for engaging an insert cartridge, a second side wall, a first rear wall, and a second rear wall, the first rear wall acting as a stop for the insert cartridge when the insert cartridge is mounted in the pocket in a locked condition, wherein the top wall and the bottom wall are formed at a negative angle with respect to each other, thereby providing a closed pocket design that resists centrifugal forces during a cutting operation.

In another aspect of the invention, a cutting tool comprises a pocket including a top wall, a bottom wall, a first side wall for engaging an insert cartridge, a second side wall, a first rear wall, and a second rear wall, wherein the top wall and the bottom wall are formed at a negative angle with respect to each other. The insert cartridge comprises a top wall, a bottom wall opposite the top wall, a front wall, a rear wall opposite the rear wall, a pair of opposing side walls extending between the top and bottom walls, and an insert pocket formed in the top wall at an intersection between the front wall and one of the side walls for receiving a cutting insert. The clamp wedge comprises a top wall, a bottom wall opposite the top wall, a front wall, a rear wall opposite the front wall, and a pair of opposing side walls extending between the top and bottom walls. The top wall of the clamp wedge engages the top wall of the pocket, and the bottom wall of the clamp wedge engages the top wall of the insert cartridge to securely hold the insert cartridge in the pocket during a cutting operation.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is an isometric view of a cutting tool with a pocket having a closed pocket design in accordance with an embodiment of the invention;

FIG. 2 is a front view showing a negative angle between the top wall and the bottom wall of the pocket of FIG. 1;

FIG. 3 is an isometric view of an insert cartridge according to an embodiment of the invention;

FIG. 4 is an isometric view of a clamp wedge according to an embodiment of the invention;

FIG. 5 is an isometric view of the insert cartridge and clamp wedge when mounted in the pocket in an unlocked condition;

FIG. 6 is a front view of the insert cartridge and clamp wedge when mounted in the pocket in an unlocked condition;

FIG. 7 is an isometric view of the insert cartridge and clamp wedge when mounted in the pocket in a locked condition; and

FIG. 8 is a front view of the insert cartridge and clamp wedge when mounted in the pocket in a locked condition.

### DETAILED DESCRIPTION OF THE INVENTION

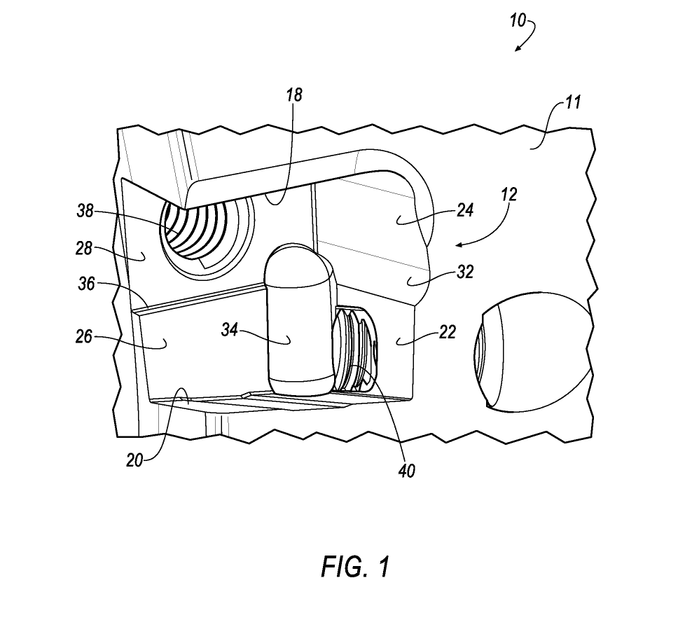

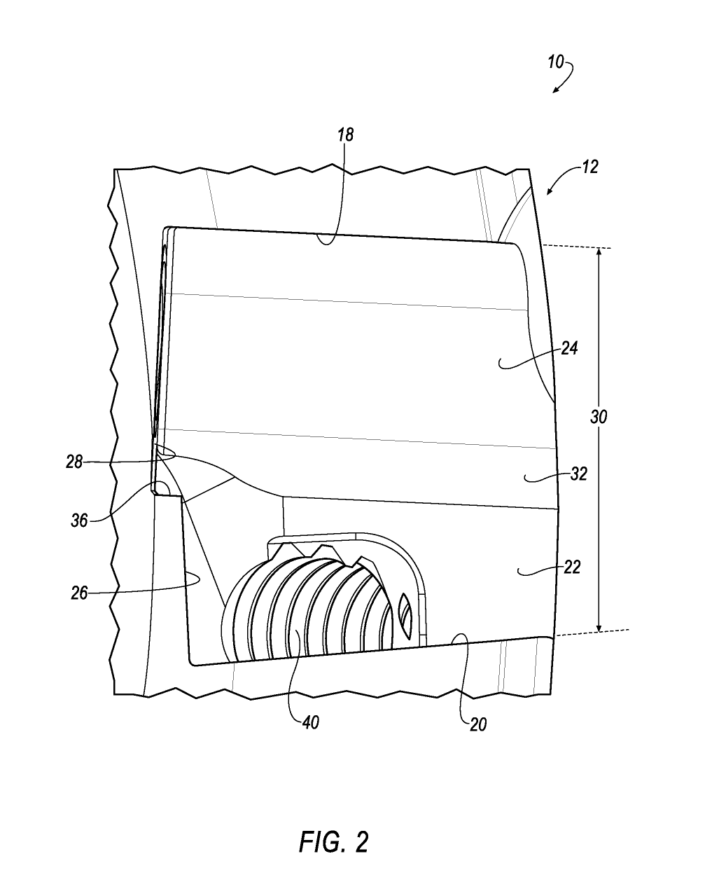

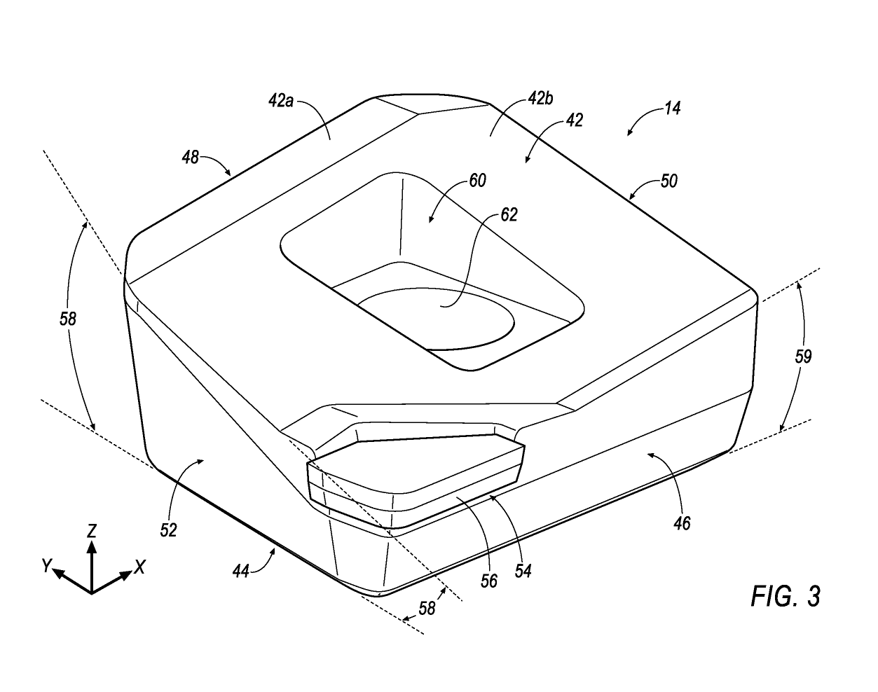

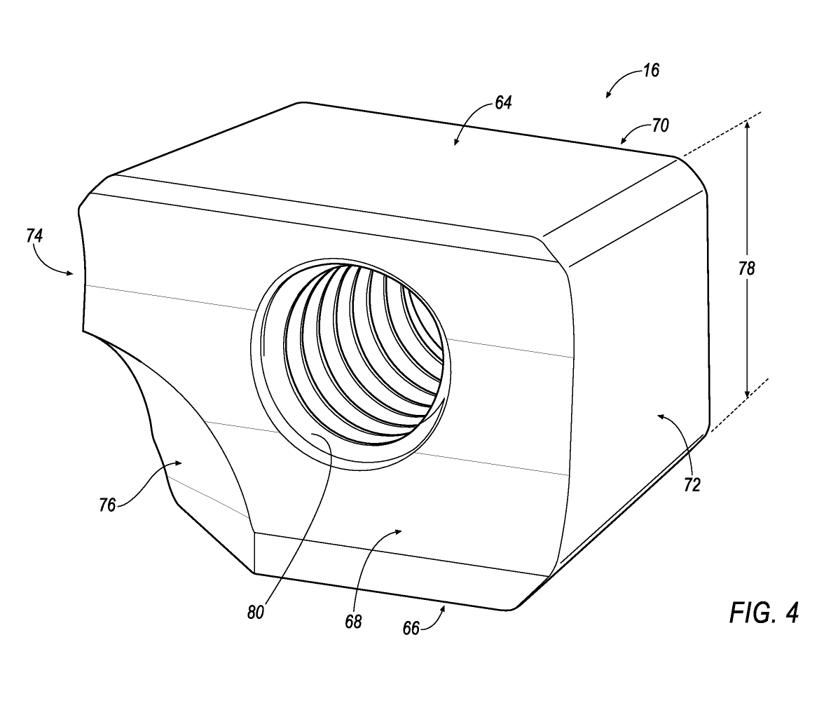

Referring now to FIGS. 1 and 2, a cutting tool 10, for example, a milling cutter, includes a body 11 with a pocket 12 having a closed pocket design is shown according to an embodiment of the invention. It will be appreciated that the cutting tool 10 may include a plurality of pockets 12, but only one pocket 12 is shown in FIGS. 1 and 2 for brevity and clarity. The pocket 12 is capable of receiving an insert cartridge 14 and a clamp wedge 16, shown generally in FIGS. 3 and 4, respectively.

In general, the pocket 12 includes a top wall 18, a bottom wall 20, a first side wall 22 for engaging the insert cartridge 14, a second side wall 24, a first rear wall 26, and a second rear wall 28. The first rear wall 26 acts as a stop for the insert cartridge 14 when the insert cartridge 14 is mounted in the pocket 12 in a locked condition. One aspect of the invention is that the top wall 18 and the bottom wall 20 are formed at a negative angle 30 (i.e., less than 0 degrees) with respect to each other, as shown in FIG. 2. The negative angle 30 provides a closed pocket design of the invention that resists centrifugal forces during a cutting operation, unlike conventional cutting tools with open pocket designs.

The pocket 12 may also include a first corner radius 32 between the first side wall 22 and the second side wall 24. In addition, the pocket 12 may include a second corner radius 34 between the first side wall 22 and the first rear wall 26. The first and second corner radius 32, 34 reduce stress in the pocket 12. The pocket 12 may also include a ledge 36 at the interface between the first rear wall 26 and the second rear wall 28. Because the second rear wall 28 has a greater depth than the first rear wall 26, the ledge 36 provides clearance between the insert cartridge 14 and the second rear wall 28 when the insert cartridge 14 is in a locked condition.

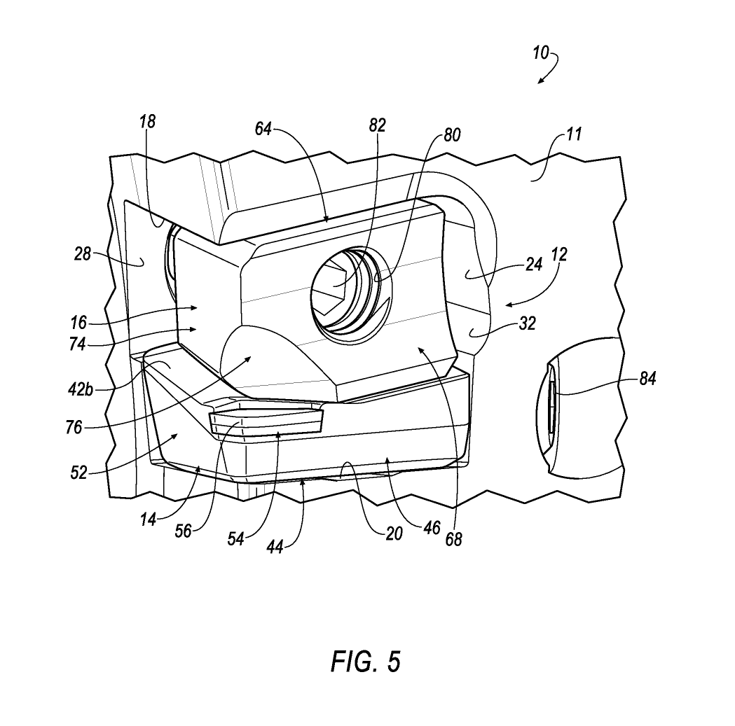

The second rear wall 28 of the pocket 12 includes a threaded bore 38 for receiving a wedge screw 82 (FIG. 5). The threaded bore 38 is formed at an angle (not shown) that is not perpendicular with respect to the second rear wall 28. In addition, the first side wall 22 may include a threaded bore 40 formed through the body 11 for receiving an axial seating screw 84 (FIG. 5). Like the threaded bore 38, the threaded bore 40 is formed at an angle (not shown) that is not perpendicular with respect to the first side wall 22. However, the threaded bore 40 and the optional axial seating screw 84 can be omitted, if desired.

Referring now to FIG. 3, the insert cartridge 14 is shown according to an embodiment of the invention. The insert cartridge 14 is generally rectangular in shape having a top wall 42, a bottom wall 44 opposite the top wall 42, a front wall 46, a rear wall 48 opposite the front wall 46, and a pair of opposing side walls 50, 52 extending between the top and bottom walls 42, 44. In general, the top wall 42, the bottom wall 44, the front wall 46, the rear wall 48 and the side walls 50, 52 are substantially planar. An insert pocket 54 is formed in the top wall 42 at an intersection between the front wall 46 and one of the side walls 50, 52 for receiving a blade or cutting insert 56. In the illustrated embodiment, the insert pocket 54 is formed in the top wall 42 between the front wall 46 and the side wall 52. The cutting insert 56 can be mounted in the insert pocket 54 using any well-known means in the art, such as brazing, and the like.

In general, the top wall 42 is not perpendicular to the side walls 50, 52, while the bottom wall 44, the front wall 46 and the rear wall 48 are substantially perpendicular to the side walls 50, 52. In addition, a first portion 42a of the top wall 42 is also formed substantially perpendicular to the front wall 46, the rear wall 48 and the side walls 50, 52. However, in one aspect of the invention, a second portion 42b of the top wall 42 is formed at an angle 58 greater than or equal to 0 degrees with respect to the bottom wall 44 along the y-axis passing through the front and rear walls 46, 48. In addition, the second portion 42b of the top wall 42 is formed at an angle 59 greater than or equal to 0 degrees with respect to the bottom wall 44 along the x-axis passing through the side walls 50, 52. Thus, the second portion 42b of the top surface 42 is sloped downward in the direction of both the x- and y-axes toward the insert pocket 54. In other words, the second portion 42b of the top wall 42 is not parallel with respect to the bottom wall 44 and a thickness of the insert cartridge 14 is smallest proximate the insert pocket 54. When the insert cartridge 14 and the clamp wedge 16 are in the locked condition, the bottom wall 44 engages the bottom wall 20 of the pocket 12, and the second portion 42b of the top wall 42 acts as a seating surface for the clamp wedge 16 to resist the insert cartridge 14 from sliding out of the pocket 12 during a cutting operation. The second portion 42b of the top wall 42 also includes a recess 60 and a bore 62 for reducing weight of the insert cartridge 14, thereby reducing the centrifugal forces experienced by the cutting tool 10 during a cutting operation.

Referring now to FIG. 4, the wedge clamp 16 is shown according to an embodiment of the invention. The wedge clamp 16 is generally rectangular in shape having a top wall 64, a bottom wall 66 opposite the top wall 64, a front wall 68, a rear wall 70 opposite the front wall 70, and a pair of opposing side walls 72, 74 extending between the top and bottom walls 64, 66. In general, the top wall 64, the bottom wall 66, the rear wall 70 and the side walls 72, 74 are substantially planar. A chip gash 76 is formed in the bottom wall 66 at an intersection between the front wall 68 and one of the side walls 72, 74 for effective evacuation of chips produced by the cutting insert 56 during a cutting operation. In addition, the front wall 68 is substantially arcuate in shape to provide additional aid in the evacuation of chips during a cutting operation.

In general, the top wall 64, the bottom wall 66, the front wall 68 and the rear wall 70 are substantially perpendicular to the side walls 72, 74. However, in one aspect of the invention, the top wall 64 is formed at an angle 78 greater than or equal to 0 degrees with respect to the bottom wall 66. In other words, the top wall 64 is not parallel with respect to the bottom wall 66 such that a thickness of the wedge clamp 16 is largest proximate the front wall 68 and smallest proximate the rear wall 70. When the insert cartridge 14 and the clamp wedge 16 are in the locked condition, the top wall 64 engages the top wall 18 of the pocket 12, and the bottom wall 66 engages the second portion 42b of the top wall 42 of the insert cartridge 16 to resist the insert cartridge 14 from sliding out of the pocket 12 during a cutting operation. The clamp wedge 16 also includes a threaded bore 80 extending from the front wall 68 through the rear wall 70 to allow the wedge screw 82 (FIG. 5) to pass therethrough.

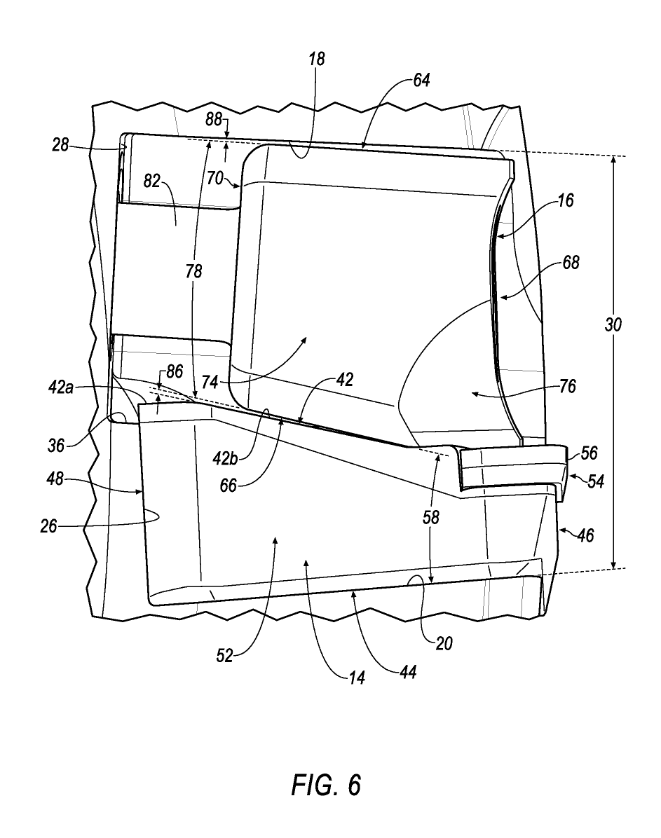

FIGS. 5 and 6 show the insert cartridge 14 and the clamp wedge 16 mounted in the pocket 12 in an unlocked condition. As shown in FIG. 6, a small gap 86 exists between a portion of the second portion 42b of the top wall 42 of the insert cartridge 14 and the bottom wall 66 of the wedge clamp 16. In addition, a small gap 88 exists between the top wall 18 of the pocket 12 and the top wall 64 of the wedge clamp 16 when the insert cartridge 14 and the clamp wedge 16 are in the unlocked condition. The gaps 86, 88 are a result of the relative difference between the angles 58, 78 between insert cartridge 14 and the clamp wedge 16, respectively.

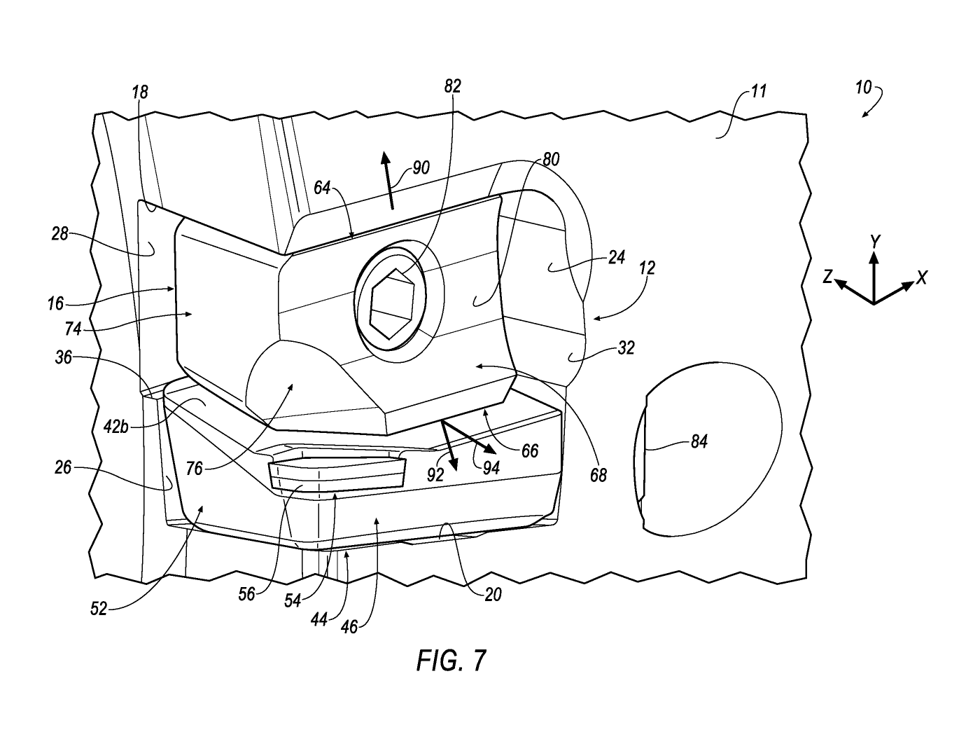

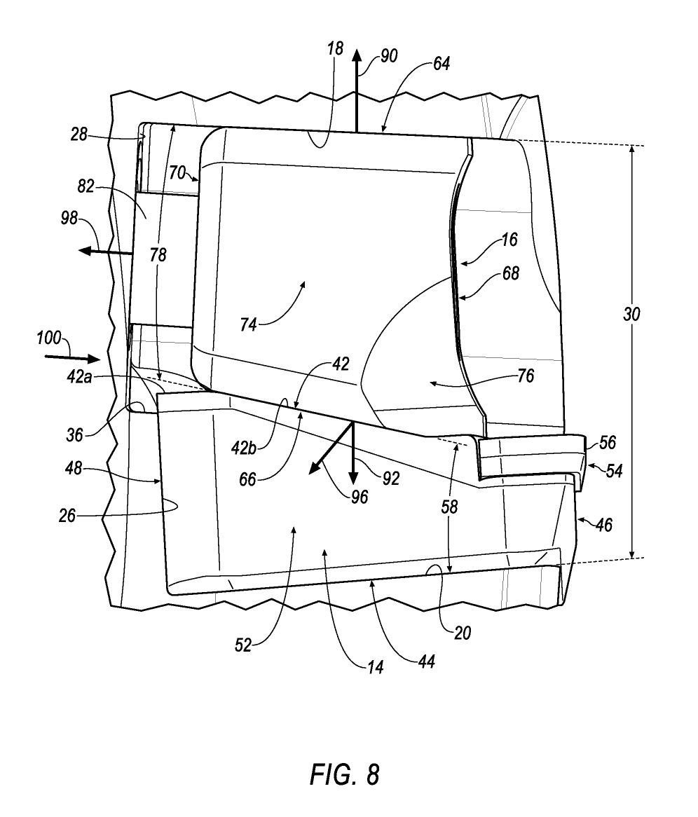

FIGS. 7 and 8 show the insert cartridge 14 and the clamp wedge 16 mounted in the pocket 12 in a locked condition. As shown in FIG. 8, the clamp wedge 16 moves rearward with respect to the insert cartridge 14 as the clamp screw 82 is threaded into the threaded bore 80 when compared to FIG. 7. As a result of this relative movement, the gaps 86, 88 no longer exist due to the closed pocket design in the invention in which the negative angle 30 exists between the top wall 18 and the bottom wall 20 of the pocket 12, thereby causing the clamp wedge 16 to securely hold the insert cartridge 14 in the pocket 12.

FIG. 7 shows force vectors 90, 92, 94 in the axial direction (along the x-axis) due to the clamping forces when the insert cartridge 14 and the clamp wedge 16 are in the locked condition. Specifically, the force vector 90 is due to the interaction between the top wall 18 of the pocket 12 and the top wall 64 of the clamp wedge 16, the force vector 92 is due to the interaction between the bottom wall 20 of the pocket 12 and the bottom wall 44 of the insert cartridge 14, and the force vector 94 is due to the interaction between the top wall 42 of the insert cartridge 14 and the bottom wall 66 of the clamp wedge 16.

FIG. 8 shows additional force vectors 96, 98 in the radial direction (along the z-axis) due to the clamping forces when the insert cartridge 14 and the clamp wedge 16 are in the locked condition. Specifically, the force vector 96 is due to the interaction between the top wall 42 of the insert cartridge 14 and the bottom wall 66 of the clamp wedge 16. The force vector 98 is due to the clamp screw 82 being threaded into the threaded bore 80. The force vector 98 ensures full face seating between the insert cartridge 14 and the clamp wedge 16. In addition, the force vector 98 is not parallel to the centrifugal force vector 100, thereby reducing tensile stress on the clamp screw 82 during a cutting operation.

As described above, the closed pocket design of the invention due to the negative angle 30 between the top wall 18 and the bottom wall 20 of the pocket 12 causes the clamp wedge 16 to press against the top wall 18 and the bottom wall 20 of the pocket 12 to securely hold the insert cartridge 14 in place when in the locked condition during a cutting operation. In addition, the relative differences between the angles 58, 59 and 78 causes the force vectors 90, 92, 94 to be applied in the direction of all three axes (x-, y- and z-axes) to counter centrifugal forces and securely hold the insert cartridge 14 in place during a cutting operation.

The patents and publications referred to herein are hereby incorporated by reference.

Having described presently preferred embodiments the invention may be otherwise embodied within the scope of the appended claims.

What is claimed is:

1. A cutting tool comprising a pocket including a top wall, a bottom wall, a first side wall for engaging an insert cartridge, a second side wall, a first rear wall, and a second rear wall, wherein the top wall and the bottom wall are formed at a negative angle with respect to each other, thereby providing a closed pocket design that resists centrifugal forces during a cutting operation.

2. The cutting tool according to claim 1, wherein the pocket further comprises a first corner radius between the first side wall and the second side wall, and a second corner radius between the first side wall and the first rear wall.

3. The cutting tool according to claim 1, wherein the insert cartridge comprises a top wall, a bottom wall opposite the top wall, a front wall, a rear wall opposite the rear wall, a pair of opposing side walls extending between the top and bottom walls, and an insert pocket formed in the top wall of the insert cartridge at an intersection between the front wall of the insert cartridge and one of the side walls of the insert cartridge for receiving a cutting insert.

4. The cutting tool according to claim 3, wherein the top wall of the insert cartridge has a first portion and a second portion.

5. The cutting tool according to claim 4, wherein the second portion is formed at an angle greater than or equal to 0 degrees with respect to the bottom wall in a direction along a y-axis passing through the front and rear walls of the insert cartridge, and is formed at an angle greater than or equal to 0 degrees with respect to the bottom wall of the insert cartridge along an x-axis passing through the side walls of the insert cartridge.

6. The cutting tool according to claim 1, wherein the clamp wedge includes a top wall, a bottom wall opposite the top wall, a front wall, a rear wall opposite the front wall, and a pair of opposing side walls extending between the top and bottom walls.

7. The cutting tool according to claim 6, wherein the clamp wedge further includes a chip gash formed in the bottom wall of the clamp wedge between the front wall of the clamp wedge and one of the side walls of the clamp wedge for effective evacuation of chips produced by a cutting insert during a cutting operation.

8. The cutting tool according to claim 6, wherein the top wall (64) of the wedge clamp is formed at an angle greater than or equal to 0 degrees with respect to the bottom wall of the wedge clamp.

9. The cutting tool according to claim 1, wherein the first rear wall acts as a stop for the insert cartridge when the insert cartridge is mounted in the pocket in a locked condition.

10. A cutting tool comprising a pocket including a top wall, a bottom wall, a first side wall for engaging an insert cartridge, a second side wall, a first rear wall, and a second rear wall, wherein the top wall and the bottom wall are formed at a negative angle with respect to each other,
the insert cartridge comprising:
a top wall, a bottom wall opposite the top wall, a front wall, a rear wall opposite the rear wall, a pair of opposing side walls extending between the top and bottom walls, and an insert pocket formed in the top wall at an intersection between the front wall and one of the side walls for receiving a cutting insert;
the clamp wedge comprising:
a top wall, a bottom wall opposite the top wall, a front wall, a rear wall opposite the front wall, and a pair of opposing side walls extending between the top and bottom walls,
wherein the top wall of the clamp wedge engages the top wall of the pocket, and the bottom wall of the clamp wedge engages the top wall of the insert cartridge to securely hold the insert cartridge in the pocket during a cutting operation.

11. The cutting tool according to claim 10, wherein the top wall of the insert cartridge has a first portion and a second portion.

12. The cutting tool according to claim 11, wherein the second portion is formed at an angle greater than or equal to 0 degrees with respect to the bottom wall in a direction along a y-axis passing through the front and rear walls, and is formed at an angle greater than or equal to 0 degrees with respect to the bottom wall along an x-axis passing through the side walls.

13. The cutting tool according to claim 11, wherein the top wall of the wedge clamp is formed at an angle greater than or equal to 0 degrees with respect to the bottom wall of the wedge clamp.

14. The cutting tool according to claim 10, wherein the pocket further comprises a first corner radius between the first side wall and the second side wall, and a second corner radius between the first side wall and the first rear wall.

15. The cutting tool according to claim 10, wherein the first rear wall acts as a stop for the insert cartridge when the insert cartridge is mounted in the pocket in a locked condition.
